(19) United States
(12) Patent Application Publication
(10) Pub. No.: US 2013/0097103 A1
(43) Pub. Date: Apr. 18, 2013

(54) Techniques for Generating Balanced and Class-Independent Training Data From Unlabeled Data Set

(71) Applicants: Suresh N. Chari, Scarsdale, NY (US); Ian Michael Molloy, White Plains, NY (US); Youngja Park, Princeton, NJ (US); Zijie Qi, Davis (CA)

(72) Inventors: Suresh N. Chari, Scarsdale, NY (US); Ian Michael Molloy, White Plains, NY (US); Youngja Park, Princeton, NJ (US); Zijie Qi, Davis (CA)

(73) Assignee: International Business Machines Corporation, Armonk, NY (US)

(21) Appl. No.: 13/274,002

(22) Filed: Oct. 14, 2011

(51) Int. Cl. G06F 15/18; G06F 17/30

(52) U.S. Cl. 706/12; 707/737; 707/E17.089

(57) ABSTRACT

Techniques for creating training sets for predictive modeling are provided. In one aspect, a method for generating training data from an unlabeled data set is provided which includes the following steps. A small initial set of data is selected from the unlabeled data set. Labels are acquired for the initial set of data selected from the unlabeled data set resulting in labeled data. The data in the unlabeled data set is clustered using a semi-supervised clustering process along with the labeled data to produce data clusters. Data samples are chosen from each of the clusters to use as the training data. The selecting, presenting, clustering and choosing steps are repeated with one or more additional sets of data selected from the unlabeled data set until a desired amount of training data has been obtained, wherein at each iteration an amount of the labeled data is increased.

### FIELD OF THE INVENTION

The present invention relates to data mining and machine learning and more particularly, to improved techniques for generating training samples for predictive modeling.

### BACKGROUND OF THE INVENTION

Supervised learning algorithms (i.e., classification) can provide promising solutions to many real-world problems such as text classification, medical diagnosis, and information security. A major limitation of supervised learning in real-world applications is the difficulty in obtaining labeled data to train predictive models. It is well known that the classification performance of a predictive model depends crucially on the quality of training data. Ideally one would like to train classifiers with diverse labeled data fully representing all classes. In many domains, such as text classification or security, there is an abundant amount of unlabeled data, but obtaining representative subset is very challenging since the data is typically highly skewed and sparse. For instance, in intrusion detection, the percentage of total netflow data containing intrusion attempts can be less than 0.0001%.

There are two widely used approaches for generating training data. They are random sampling and active learning. Random sampling, a low-cost approach, produces a subset of the data which has a distribution similar to the original data set, producing skewed results for imbalanced data. Training with the resulting labeled data yields poor results as indicated in recent work on the effect of class distribution on learning and performance degradation caused by class imbalances. See, for example, Jo et al., “Class Imbalances versus Small Disjuncts,” SIGKDD Explorations, vol. 6, no. 1, 2004; Weiss et al., “The effect of class distribution on classifier learning: An empirical study,” Dept. of Comp. Science, Rutgers University, Tech. Rep. ML-TR-44 (Aug. 2, 2001); Zadrozny, “Learning and evaluating classifiers under sample selection bias,” in Proceedings of the 21^{st} International Conference on Machine Learning, Banff, Canada 2004 (ICML, 2004)).

Active learning produces training data incrementally by identifying most informative data for labeling at each phase. See, for example, Dasgupta et al., “Hierarchical sampling for active learning,” in Proceedings of the 25^{st} International Conference on Machine Learning, Helsinki, Finland 2008 (ICML 2008); Ertekin et al., “Learning on the border: active learning in imbalanced data classification,” in CIKM 2007; and Settles, “Active learning literature survey,” University of Wisconsin-Madison, Computer Sciences Technical Report 1648, 2009 (hereinafter “Settles”). However, active learning requires knowing a classifier and the parameters for the classifier in advance, which is not feasible in many real applications, as well as costly re-training at each step.

Therefore, improved techniques for generating training data would be desirable.

### SUMMARY OF THE INVENTION

The present invention provides improved techniques for creating training sets for predictive modeling. Further, a method for generating training data from an unlabeled data set without using any classifier is provided. In one aspect of the invention, a method for generating training data from an unlabeled data set is provided. The method includes the following steps. A small initial set of data is selected from the unlabeled data set. Labels are acquired for the initial set of data selected from the unlabeled data set resulting in labeled data. The data in the unlabeled data set is clustered using a semi-supervised clustering process along with the labeled data to produce a plurality of data clusters. Data samples are chosen from each of the clusters to be used as the training data. The selecting, presenting, clustering and choosing steps are repeated with one or more additional sets of data selected from the unlabeled data set until a desired amount of training data has been obtained, wherein at each iteration the amount of the labeled data is increased. In another aspect of the invention, a method for incorporating domain knowledge in the training data generation process is provided.

When domain knowledge is available, it can be used to estimate class distributions. Domain knowledge may come in many forms, such as conditional probabilities and correlation, e.g., there is a heavy skew in the geographical location of servers hosting malware. Domain knowledge may be used to improve the convergence of the iterative process and yield more balanced sets.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary methodology for obtaining balanced training sets according to an embodiment of the present invention;

FIG. 2 is a diagram illustrating an exemplary methodology for using semi-supervised clustering to partition a data set into balanced clusters according to an embodiment of the present invention;

FIG. 3 is a diagram illustrating an exemplary methodology for determining the number of samples to draw based on previously labeled samples and the number of samples to draw by random sampling at each iteration t according to an embodiment of the present invention;

FIG. 4 is a diagram illustrating an exemplary methodology for determining the number of samples to draw based on previously labeled samples and the number of samples to draw based on extra domain knowledge provided by domain experts according to an embodiment of the present invention;

FIG. 5 is a diagram illustrating a maximum entropy sampling strategy according to an embodiment of the present invention;

FIG. 6 is a table summarizing characteristics of several experimental data sets used to validate the method according to an embodiment of the present invention;

FIGS. 7A-D are diagrams illustrating the increase of balancedness in the training set over iterations obtained by the present sampling method on four different data sets according to an embodiment of the present invention;

FIG. 8 is a table summarizing the distance of class distributions obtained by the present sampling method to uniform distance according to an embodiment of the present invention;

FIG. 9 is a table showing recall rate of binary data sets according to an embodiment of the present invention;

FIG. 10 is a table illustrating classifier performance given sampling technique according to an embodiment of the present invention;

FIGS. 11A and 11B are diagrams illustrating performance of the present method with domain knowledge according to an embodiment of the present invention;

FIGS. 12A and 12B are diagrams illustrating sampling from a Dirichlet distribution according to an embodiment of the present invention;

FIGS. 13A and 13B are diagrams illustrating recursive binary clustering and k-means with k=20 according to an embodiment of the present invention; and

FIG. 14 is a diagram illustrating an exemplary apparatus for performing one or more of the methodologies presented herein according to an embodiment of the present invention.

### DETAILED DESCRIPTION OF PREFERRED EMBODIMENTS

Given the above-described problems associated with the conventional approaches to creating training data sets for predictive modeling, the present techniques address the problem of selecting a good representative subset which is independent of both the original data distribution as well as the classifier that will be trained using the labeled data. Namely, presented herein are new strategies to generate training samples from unlabeled data which overcomes limitations in random and existing active sampling.

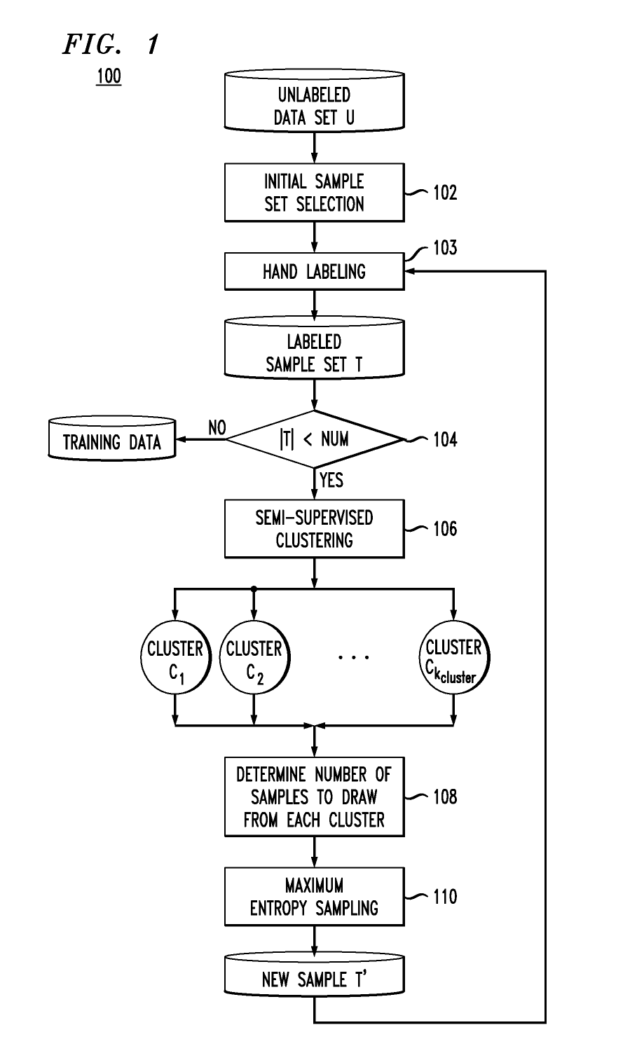

The core methodology 100 (see FIG. 1, described below) is an iterative process to sample for labeling a small fraction (e.g., 10%) of the desired training set at each time, without relying on classification models. In each iteration, semi-supervised clustering is used to embed prior knowledge (i.e., labeled samples) to produce clusters close(r) to the true classes. See, for example, Bar-Hillel et al., “Learning a mahalanobis metric from equivalence constraints,” Journal of Machine Learning Research, vol. 6, pgs. 937-965 (2005) (hereinafter “Bar-Hillel”); Wagstaff et al., “Clustering with instance-level constraints,” in Proceedings of the 17^{th} International Conference on Machine Learning 2000 (ICML 2000) (hereinafter “Wagstaff”) and Xing et al., “Distance metric learning, with application to clustering with side-information,” in Advances in Neural Information Processing Systems 15, MIT Press (2003) (hereinafter “Xing”), the contents of each of which are incorporated by reference herein. Once such clusters are obtained, strategies are presented to estimate the class distribution of the clusters based on labeled samples. With this estimation, the present techniques attempt to increase the balancedness of the training sample in each iteration by biased sampling.

Several strategies are presented to estimate the cluster class density: A simple approach would be to assume that the class distribution in a cluster is the same as the distribution of known labels within the cluster, and to draw samples proportionally to the estimated class distribution. However, this approach does not work well in early iterations when the number of labeled samples is small and there is higher uncertainty about the class distribution. The second approach views sampling from a cluster as drawing samples from a multinomial distribution with unknown mass function. The known labels within a cluster are used to define the hyperparameters of a Dirichlet from which a multinomial is sampled. This approach is conceptually more sound, however this approach does not work well either when there are few samples and high uncertainty. Thus, hybrid approaches are presented herein that address this issue and perform well in practice.

Strategies are also presented where additional domain knowledge is available. The domain knowledge can be used to estimate the class distributions to improve the convergence of the iterative process and to yield more balanced sets. In many applications, which features are indicative of certain classes is often intuitive. For instance, there is a heavy skew in the geographical location of servers hosting malware. See, for example, Provos et al., “All Your iFRAMES Point to Us,” Google, Tech. Rep. (2008) (hereinafter “Provos”), the contents of which are incorporated by reference herein. To model domain knowledge, input correlations between certain features or feature-values with classes are allowed. Such expert domain knowledge is used to estimate the class distribution within the cluster at each iteration. This is especially useful in the earlier iterations when the number of labeled samples is small and there is higher uncertainty about the class distribution within the cluster.

The sampling methods presented herein are very generic and can be used in any application where we want a balanced sample irrespective of the underlying data distribution. The strategy for generating balanced training sets is now described. First a high level overview of the present methodology is described in conjunction with the description of FIG. 1 followed by a more detailed description with specific instantiations of the key steps and a discussion of various tradeoffs.

Now presented is an overview of the process which provides a high level intuitive guide through the methodology 100 (FIG. 1) for obtaining balanced training sets. The present techniques provide a solution where there is an unlabeled data set with unknown class distribution, and the goal is to produce balanced labeled samples for training predictive models. If one assumes that the labels of the samples in the data set are known a priori, one can use over and under-sampling to draw a balanced sample set. See, for example, Liu et al., “Exploratory under-sampling for class-imbalance learning,” IEEE Trans. On Sys. Man. And Cybernetics (2009) (hereinafter “Liu”); Chawla et al., “Smote: Synthetic minority over-sampling technique,” Journal of Artificial Intelligence Research (JAIR), vol. 16, pgs. 321-357 (2002) (hereinafter “Chawla”); Wu et al., “Data selection for speech recognition,” in IEEE workshop on Automatic Speech Recognition and Understanding (ASRU) (2007) (hereinafter “Wu”), the contents of each of which are incorporated by reference herein. In practice, however, the class labels are not known and instead a series of approximations must be used to approach the results of this ideal solution. An iterative method is applied herein, where, in each iteration, the present method draws (selects) a batch of samples (B), and domain experts provide the labels of the selected samples. Information embedded in the labeled sample is used to group together data elements which are very similar to the labeled sample using semi-supervised clustering. The class distribution in the clusters can then be estimated and used to perform a biased sampling of clusters to obtain a diverse balanced sample. Within each cluster, a diverse sample is obtained by using a maximum entropy sampling. The sample obtained at each iteration is then labeled and used in subsequent iterations.

FIG. 1 gives a high level description of the strategy. Data is taken from an unlabeled data set. See “Unlabeled Data Set U” in FIG. 1. As highlighted above, the starting point for the methodology is an initial (possibly empty, i.e., when an initial set is empty, no labeled data exists at the first iteration) set of labeled samples selected from the unlabeled data set. In step 102, a small set of data (e.g., from about 5% to about 10% of the desired training data set), is selected (sampled) from Data Set U. According to one exemplary embodiment, this initial sample set is created by random sampling, but other methods can be used such as an initial set provided by a domain expert, or one can use a clustering system to select an initial set of samples. Once this given percentage of the desired training size (also referred to herein as “a batch”) is selected, this amount of data (batch size) will be added to the training sample set iteratively, as described below. In step 103, class labels of this small initial sample of the data are provided. According to an exemplary embodiment, the labels are provided by one or more domain experts (i.e., a person who is an expert in a particular area or topic) as is known in the art, e.g., by hand labeling the data. This small initial sample of labeled data is used for semi-supervised clustering to be performed as described below.

The labeled data samples are added into the training data set T. See “Labeled Sample set T” in FIG. 1. In step 104, a determination is made as to whether the data set T contains the number of training samples the user wants to produce (‘num’). If it does, i.e., |T|>num, then the labeled sample set T is stored as training data. See “Training Data” in FIG. 1. However, if the data set T does not contain num training samples, i.e., |T|<num, then the system selects additional samples. It is noted that, as will be described in detail below, the number of samples to select, num, is one of the input parameters to methodology 100.

The remaining samples to be labeled are picked in an iterative fashion, where each iteration produces a fraction of the desired sample size. In each iteration, semi-supervised clustering is applied to the data, incorporating the labeled samples from previous iterations. See step 106. As is known in the art, semi-supervised clustering employs both labeled (e.g., known labels from the previous iterations) and unlabeled data for training. Specifically, in step 106, the data from Data Set U is clustered using a semi-supervised clustering process. The result of the semi-supervised clustering is a plurality of clusters C₁, C₂, . . . , C_{kcluster} (see FIG. 1) which should have a biased class distribution. An exemplary methodology for performing step 106 is provided in FIG. 2, described below.

Once the data is clustered, in step 108, a number of data points (samples) to be selected (draw) from each cluster is determined. First, the number of desired samples to draw for each class is determined based on the estimation of class distribution in the previously labeled sample set. This process is described in detail below, however, in general this step determines the class distribution of previously labeled samples regardless of their membership to particular clusters. From this information, it is determined how many samples to select for each class. Using strategies for re-sampling, members of minority classes are over-sampled and members of majority classes under-sampled to converge on a balanced sample. Next, the class distribution of previously labeled samples in each cluster is computed. Then, based on the two class distributions, the number of desired samples to draw from each cluster is determined. By way of example only, in one exemplary embodiment, the number of samples to draw from each cluster is determined by 1) computing the class distribution of previously labeled samples (regardless of their membership to particular clusters), 2) computing a number of samples to draw for each class, which is inversely proportional to the class distribution of previously labeled samples, 3) computing the class distribution of previously labeled samples in each cluster and then 4) computing the number of samples to draw from each cluster based on the distribution in the cluster.

Finally, to minimize any sample bias introduced by the semi-supervised clustering, in step 110, maximum entropy sampling is performed to draw samples from each cluster. Drawing samples from a small number of clusters to ensure balancedness introduces a risk of drawing samples that are too similar to previous samples. Maximum entropy sampling ensures a diverse sample population for classifier training. The samples chosen from the clusters are then labeled and added to the training data set, and as highlighted above methodology 100 can be repeated until a desired amount of training data is obtained.

A more detailed description of methodology 100 including the details of the implementations is now provided along with a discussion of various tradeoffs and options which yield the best experimental results. The formal definition of the balanced training set problem is as follows:

Definition 1:

Let D be an unlabeled data set containing l classes from which we wish to select n training samples. A training data set, T, is a subset of D of size n, i.e., T⊂D where |T|=n. Let L(T) be the labels of the training data set T, then the balancedness is the distance between the label distribution of L(T) and the discrete uniform distribution with f classes, i.e., D(Uniform(l)∥Multi (L(T))). The balanced training set problem is the problem of finding a training data set that minimizes this distance.

It is assumed that the number of target classes and the number of training samples to generate are known, but the class distribution in D is unknown. As described above, the first step is to apply an iterative semi-supervised clustering technique to estimate the class distribution in D and to guide the sample selection to produce a balanced set. At each iteration, methodology 100 selects B samples (i.e., the batch size) in an unsupervised fashion for labeling with L. The methodology learns domain knowledge embedded in the labeled samples and increases the balancedness of the training set in the next iteration. Methodology 100, therefore, can be regarded as a semi-supervised active learning that does not require a classifier. See FIG. 1.

According to an exemplary embodiment, methodology 100 takes three input parameters: 1) an unlabeled data set D; 2) the number of target classes in D, f; and 3) the number of samples to select, N, and produces a training data set T. Methodology 100 draws B samples, and domain experts provide the labels of the selected samples in each iteration. Users can optionally set the batch size in the beginning. Then, a semi-supervised clustering technique such as Relevant Component Analysis (RCA) is applied to embed the labels obtained from the prior steps into the clustering process, which can be used to approximate the class distributions in the clusters. The key intuition behind methodology 100 is the desire to extract more samples from clusters which are likely to increase the balancedness of the overall training set.

First, a discussion of semi-supervised clustering as used in the present techniques is now provided. At each iteration, the number of labeled samples which were used to refine clusters in the next iteration is increased. Semi-supervised clustering is a semi-supervised learning technique which incorporates existing information into clustering. A number of approaches have been proposed to embed constraints into existing clustering techniques. See, for example, Xing and Wagstaff. With the present techniques, two different strategies: a distance metric technique for multi-variate numeric data and a heuristic that adds class labels in the feature set for categorical data were explored.

For distance metric technique-based semi-supervised clustering, Relevant Component Analysis (RCA) was used (e.g., Bar-Hillel). See FIG. 2. FIG. 2 is a diagram illustrating exemplary methodology 200 for using semi-supervised clustering to partition a data set into balanced clusters. Methodology 200 represents an exemplary way for performing step 106 of FIG. 1. This is a Mahalanobis metric learning technique which finds a new space with the most relevant features in the side information. First, in step 202, labeled samples (i.e., from Labeled Sample set T, see FIG. 1) are translated into connected components, where data samples with the same class label belong to a connected component. Next, in step 204, a global distance metric parameterized by a transformation matrix Ĉ is learned to capture the relevant features in the labeled sample set. In step 206, the data is projected into a new space using the new distance metric from step 204. Methodology 200 maximizes the similarity between the original data set X and the new representation Y of the data constrained by the mutual information I(X, Y). By projecting X into the new space through transformation Y=Ĉ^{-1/2} X, two projected data objects, Yi, Yj, in the same connected component have a smaller distance.

After projecting the data set into a new space using RCA, in step 208, the data set is recursively partitioned into clusters. It is noted that generating balanced clusters (i.e., clusters with similar sizes) is beneficial for selecting diverse samples from each cluster. Hence, in a preferred embodiment, a threshold on the cluster size is provided to the semi-supervised clustering method, and the clustering process is repeated until all of the clusters are smaller than a predetermined threshold. Many different methods can be used to determine the threshold. In a preferred embodiment, the threshold of a cluster size is set to one tenth of the unlabeled data size (i.e., a cluster cannot contain more than 10% of the entire data set).

It is noted that RCA methodology 200 makes several assumptions regarding the distribution of the data. Primarily, it assumes that the data is multi-variate normally distributed, and if so, produces the optimal result. Methodology 200 has also been shown to perform well on a number of data sets when the normally distributed assumption fails (see Bar-Hillel), including many of the UCI data sets used herein. However, it is not known to work well for Bernoulli or categorical distributed data, such as the access control data sets, where it was found to produce a marginal improvement, at best.

To mitigate this problem, another semi-supervised clustering method is presented which augments the feature set with labels of known samples. It assigns a default feature value, or holding out feature values, for unlabeled samples. For example, if there are l class labels, l new features will be added. If the sample has class j, feature j will be assigned a value of 1, and all other label features a zero. Any unlabeled samples will be assigned a feature corresponding to the prior, the fraction of labeled samples with that class label. Finally, as before, the recursive k-means clustering technique described previously to cluster the data will be used. This simple heuristic produces good clusters and yields balanced samples more quickly for categorical data.

As highlighted above, once the data is clustered, methodology 100 (see FIG. 1) tries to estimate the class distribution of each cluster. The techniques for using estimates of class distribution in clusters for sampling will now be described. Specifically, once the data has been clustered, the cluster class density is estimated to obtain a biased-sample in order to increase the overall balancedness. It is assumed the semi-supervised clustering step has produced biased clusters allowing an approximation of a solution of drawing samples with known classes.

A simplistic approach is to assume that the class distribution of the cluster is exactly the same as the class distribution of the samples labeled in this cluster. This is based on the optimistic assumption that the semi-supervised clustering works perfectly and groups together elements which are similar to the labeled sample. First, determine how many samples one ideally wishes to draw from each class in this iteration from the total B samples to draw. Let lᵢ^{j} be the number of instances of class j sampled after iteration i, and ρᵢ^{j} be the normalized proportion of samples with class label j, i.e.,

$${ρ}_{i}^{j} = \frac{{l}_{i}^{j}}{{\sum }_{r} {l}_{i}^{r}} .$$

To increase the balancedness in the training step, one wants to select samples inversely proportional to their current distribution (see Liu, Chawla and Wu), i.e.,

$${n}_{j} = \frac{1 - {ρ}_{i}^{j}}{l - 1} * B ,$$

where l is the number of classes and (l−1) is the normalization factor.

Next, the estimated class distribution in each cluster is used to select the appropriate number of samples from each class. Let θᵢ^{j} be the probability of drawing a sample with class label j from the previously labeled subset of cluster i. By assumption, this is exactly the probability of drawing a sample with class label j from the entire cluster i. Since it is desired to have nⱼ samples with label j in this iteration,

$${n}_{j } \frac{{θ}_{i}^{j}}{{\sum }_{i = 1}^{κ} {θ}_{j}^{i}}$$

samples from cluster i that one optimistically expects to be from class j are drawn. Another strategy is to draw all nⱼ samples from the cluster with the maximum probability of drawing class j, however the method presented selects a more representative subset of the entire dataset D. This ensures that good results are obtained even if the estimation of cluster densities is incorrect and reduces later classifier over-fitting.

A conceptually more sound approach is to view sampling from a cluster as drawing samples from a multinomial distribution where the probability mass function for D and each cluster are unknown. The number of labeled samples in each cluster naturally defines a Dirichlet distribution, Dir (α), where αⱼ is the number of labeled samples from class j (plus one) in the cluster. Because the Dirichlet is the conjugate prior of the multinomial distribution, a multinomial distribution is drawn for the cluster, i.e., Multi (θ), where θᵢ˜Dir (α). This approach accurately models class distribution and uncertainty within each cluster. As the number of samples increases, the variance of the Dirichlet decreases and the expected value of the distribution approaches the simplistic cluster density method. Sampling a multinomial distribution for each cluster from a Dirichlet distribution whose hyperparameters are the labeled samples initially resembles random sampling and trends towards balanced until the minority classes have been exhausted.

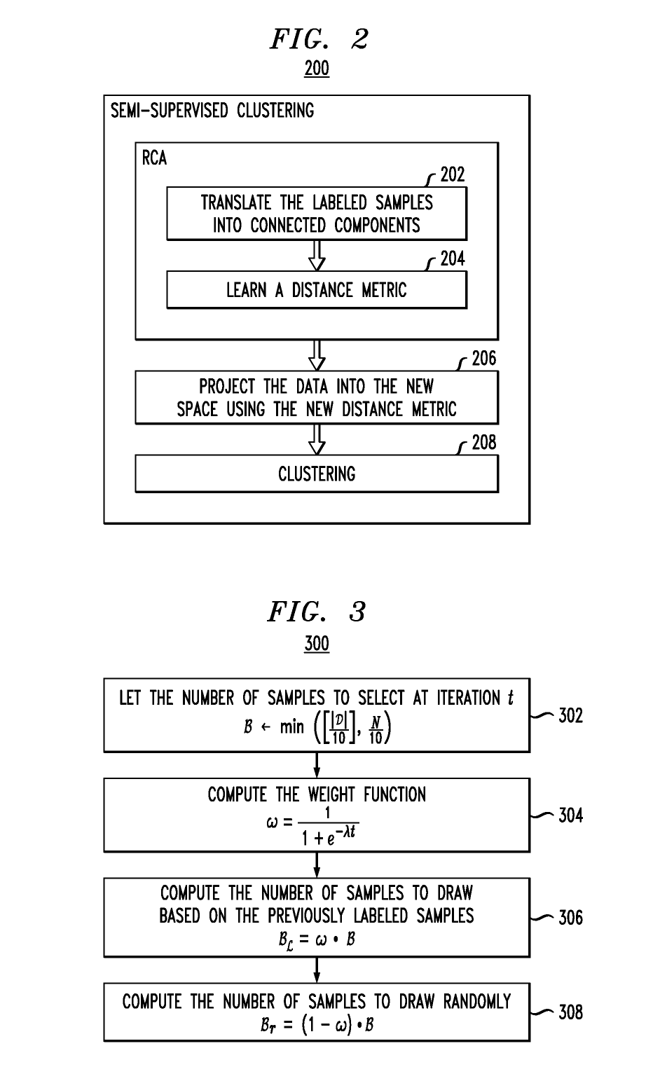

In practice, it was noticed that both the class density estimation-based approach and the Dirichlet sampling have issues in the earlier stages of the iterative process. Initially, the Dirichlet process defaults to random sampling while the naive method does not sample from clusters with no labeled samples; both skew the results. Empirically, it was noted that the best performance is with a hybrid approach where there is a mix between the simplistic method and random sampling from the clusters. The strategy is to select a certain percentage of B samples based on the class distribution estimation using the previously labeled samples and drawing the remaining samples randomly from all clusters. The influence of labeled samples over time is increased as more labeled samples are obtained and thus more accurate domain knowledge. See, for example, FIG. 3 which is a diagram illustrating an exemplary methodology 300 for determining the number of samples to draw based on previously labeled samples and the number of samples to draw by random sampling at each iteration t. In step 302, the number of samples to select at iteration t is computed as

$$β ← min ( [ \frac{\vert D \vert}{10} ] \cdot \frac{N}{10} ) .$$

Let β_{L} be the number of samples to select based on labeled samples and βᵣ be the number of samples to be selected randomly. Then, β=β_{L}+βᵣ. Next, in step 304, a weight function is computed, which decides the weight of sampling based on the labeled samples and the weight of random sampling. According to an exemplary embodiment, the following sigmoid function ω is used,

$$ω = \frac{1}{1 + {e}^{- λ t}} \qquad ( 2 )$$

wherein t denotes t-th iteration and λ is a parameter that controls the rate of mixing. In step 306, the weight function ω is used to compute the number of samples to draw based on the previously labeled samples β_{L}, and in step 308, the weight function ω is used to compute the number of samples to draw randomly, βᵣ, computed using the sigmoid function ω as in the following,

β_{L}=ω·ββᵣ=(1−ω)·β.

In the above description, cluster sampling was based on an estimation of the class distribution of each cluster using prior labeled samples. In many settings, a domain expert may have additional knowledge or intuition regarding the distribution of class labels and correlations with given features or feature values. This is often the case for many problems in security. For instance in the problem of detecting web sites hosting malware, it is well known that there is a heavy skew in geographical location of the web server. See, Provos. In the access control permissions data sets that are considered herein one can expect correlations between the department number of the employee and the permissions that are granted. This section outlines a method where one can leverage such domain knowledge to quickly converge on a more balanced training sample.

To model domain knowledge, correlations between features and class labels are assumed. These correlations may be noisy and incomplete, pertaining to only a small number of features or feature values. Without loss of generality, only binary labels will be considered with the understanding that the technique can readily be extended to non-binary labels. Domain knowledge can be applied to either stage of the process, i.e., at the first stage with regard to semi-supervised clustering, or at the second stage with regard to sampling unlabeled data samples. In semi-supervised clustering, domain knowledge can be used to select different clustering methodologies, different distance measures, or weight features by their importance. Instead, presented herein is a method that applies domain knowledge to the second stage which is specific to the present approach.

When the number of labeled samples from each cluster is small, the class density estimation has high uncertainty. See above. Expert domain knowledge is used to address this shortcoming and estimate the class distribution within a cluster, and slowly tradeoff the domain knowledge for the sampled estimate to account for noisy and inaccurate intuition. Domain knowledge is assumed in the form of a correlation value between a feature and a class label. For example, corr(misspelling, class=spam)=+0.6 or corr(Department=20, class=granted)=+0.1.

Given a small number of feature-class and feature-value-class correlations and the feature distribution within a cluster, the class density can be estimated based on domain knowledge. Independence is assumed among features and a model chosen based on the types of reasoning that may follow from such intuition. Some of the ideas from the MYCIN model of inexact reasoning are leveraged. See, for example, Shortliffe et al., “A model of inexact reasoning in medicine,” Mathematical Biosciences, vol. 23, no. 3-4 (1975) (hereinafter “Shortliffe”), the contents of which are incorporated by reference herein. They note that domain knowledge is often logically inconsistent and non-Bayesian. For example, given expert knowledge that ρ (class=granted|Department=20)=0.6, it cannot be concluded that ρ(class≠granted|Department=20)=0.4. Further, a naive Bayesian approach requires an estimation of the global class distribution, which we assume is not known a priori. Instead, this approach is based on independently aggregative suggestive evidence and leverages properties from fuzzy logic. The correlations correspond to inference rules, (Department=20→class≠granted), where the correlation coefficients are the confidence weights of the inference rules, and the feature density within each class is the degree that the given inference rule is fired. Each inference rule is evaluated in support (positive correlation) and refuting (negative correlation) the class assignments, and aggregate the results using the Product T-Conorm, norm(x, y)=x+y−x*y. Evidence supporting and refuting a class assignment is combined using the rule “class 1 and not class 2,” and T-Norm for conjunction, f(x, y)=x*(1−y).

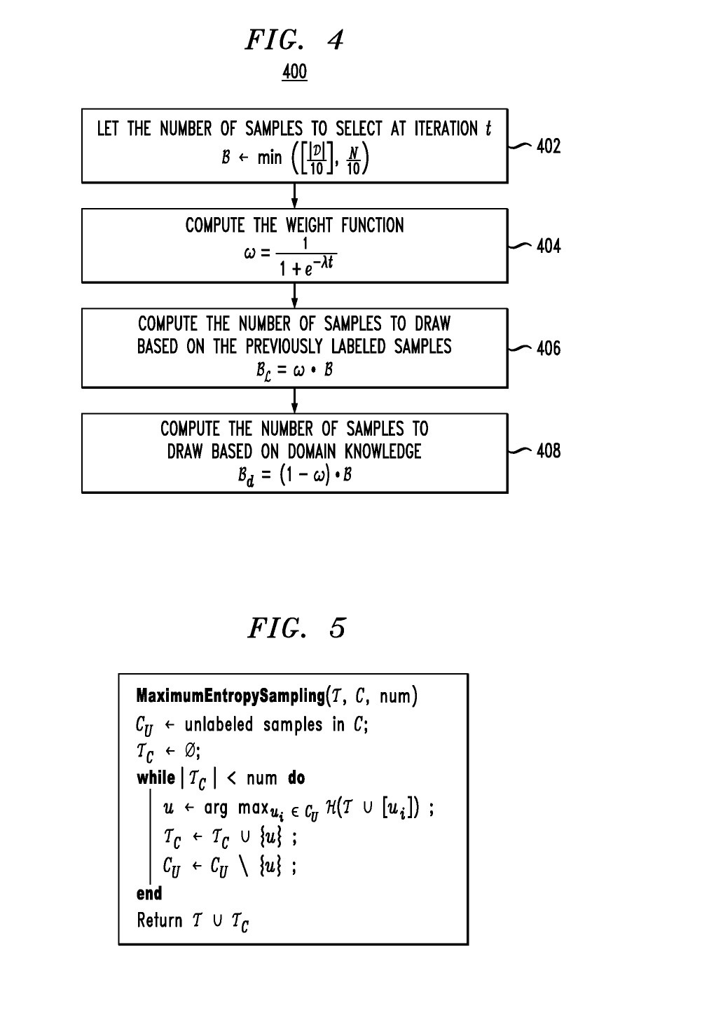

Finally, as domain knowledge is inexact and noisy, the influence of its estimates is decayed over time, favoring the empirical estimates the sigmoid function, e.g., a hybrid approach using both the class distribution estimation based on the labeled samples and the class distribution estimation based on the domain knowledge is applied instead of random sampling. See FIG. 4. FIG. 4 is a diagram illustrating an exemplary methodology 400 for determining the number of samples to draw based on previously labeled samples and the number of samples to draw based on extra domain knowledge provided by domain experts. In step 402, the number of samples to select at iteration t is computed as

$$β ← min ( [ \frac{\vert D \vert}{10} ] \cdot \frac{N}{10} ) .$$

In step 404, a weight function is computed, which decides the weight of sampling based on the labeled samples and the weight of random sampling. According to an exemplary embodiment, the same weight function as that of methodology 300 is used, i.e.,

$$ω = \frac{1}{1 + {e}^{- λ t}} ,$$

described above. In step 406, the weight function ω is used to compute the number of samples to draw based on the previously labeled samples β_{L}. In step 408, the weight function ω is used to compute the number of samples to draw based on domain knowledge, β_{d}, computed using the sigmoid function ω as in the following,

β_{L}=ω·ββ_{d}=(1−ω)·β.

Finally, a maximum entropy sampling is used to select numⱼ samples from a cluster, Cj. Maximum entropy sampling is now described. Given, a set of clusters {Cᵢ}ᵢ₌₁^{k} generated, for example, by methodology 200, a sampling method is applied that maximizes the entropy of the sampled set, L(T). It is assumed herein that the data in each cluster follows a Gaussian distribution. For a continuous variable xεCᵢ let the mean be u, and the standard deviation be σ, then the normal distribution N(β,θ²) has maximum entropy among all real-valued distributions. The entropy for a multivariate Gaussian distribution (see Santosh Srivastava et al., “Bayesian Estimation of the Entropy of the Multivariate Gaussian,” In Proc. IEEE Intl. Symp. on Information Theory (2008), the contents of which are incorporated by reference herein) is defined as:

$$H ( X ) = \frac{1}{2} d ( 1 + log ( 2 π ) ) + \frac{1}{2} log ( \vert \sum \vert ) , \qquad ( 3 )$$

wherein d is the dimension, Σ is the covariance matrix, and |Σ| is the determinant of Σ. Intuitively, the more variation the covariance matrix has along the principal directions, the more information it embeds. Note that the number of possible subsets of r elements from a cluster C can grow very large (i.e.,

$$( \frac{\vert C \vert}{γ} ) ) ,$$

so finding a subset with the global maximum entropy can be computationally very intensive.

In a preferred embodiment, a greedy method is used that selects the next sample which adds the most entropy to the existing labeled set. The present methodology performs the covariance calculation O(rn) times, while the exhaustive search approach requires O(n^{γ}). If there are no previously labeled samples, the selection starts with the two samples that have the longest distance in the cluster. The final selection is presented in FIG. 5. FIG. 5 is a diagram illustrating a maximum entropy sampling strategy.

This section presents a performance comparison of the sampling strategy with random sampling as well as uncertainty based sampling on a diverse collection of data sets. Results show that the present techniques produce significantly more balanced sets than random sampling in almost all data sets. The technique presented also performs much better than uncertainty based sampling for highly skewed sets and the present training samples can be used to train any classifier. Also described are results which demonstrate the benefits of domain knowledge and compare the performance of classifiers trained with the samples from various sampling methods.

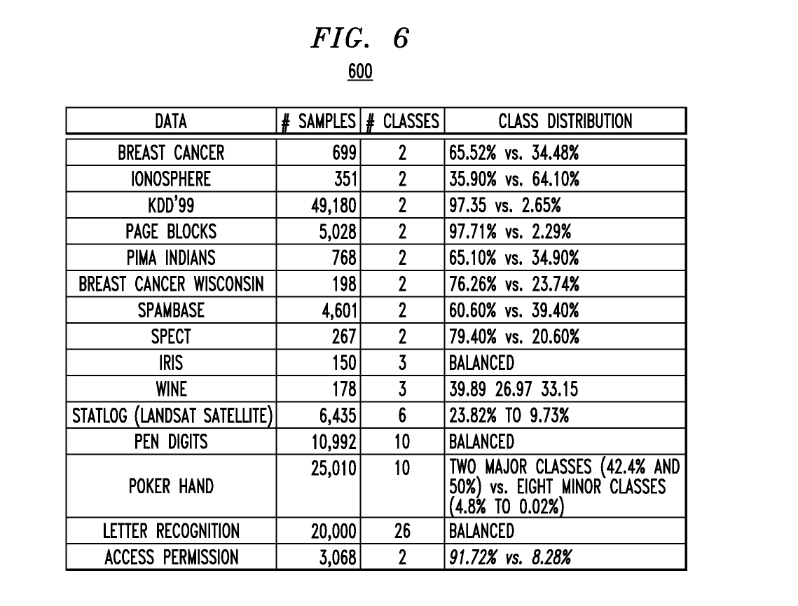

An evaluation setup is now described. The data sets used to evaluate the sampling strategies span the range of parameters: some are highly skewed while others are balanced, some are multi-class while others are binary. Fourteen data sets were selected from the UCI repository (Available online from the University of California Irvine (UCI) Machine Learning Repository) and 105 data sets which arise from the assignment of access control permissions to a set of users. The UCI data sets include both binary and multi-class classification problems. All UCI data sets are used unmodified except the KDD Cup '99 set which contains a “normal” class and 20 different classes of network attacks. In this experiment, only “normal” class and “guess password” class were selected to create a highly skewed data set. When a data set was provided with a training set and a test set separately (e.g., ‘Statlog’), the two sets were combined. The access control data sets specify if a user is granted or denied access to a specific computing resource. The features for this data set are typically organization attributes of a user: department name, job roles, whether the employee is a manager, etc. The features are all categorical which are then converted to binary features and the data sets are highly sparse (typically about 5% of users are granted a particular permission). Since, typically, such access control permissions are assigned based on a combination of attributes, these data sets are also useful to assess the benefits of domain knowledge. For each data set 80% of the data set was randomly selected to be used to generate the training set and use classifiers trained with this training set to classify the remaining 20% of the samples. Each result reported is the average of 10 runs of this experiment, core evaluation framework. FIG. 6 is a table 600 that summarizes the size and class distribution of these data sets. In table 600, the access permission shows the average values of 105 data sets.

Three widely used classification techniques are considered, Naive Bayes, Logistic Regression, and SVM, to be used with uncertainty based sampling and these variants are labeled (Un Naive), (Un LR), and (Un SVM) respectively. All classification experiments were conducted using RapidMiner, an open source machine learning tool kit. See Mierswa et al., “Yale: Rapid Prototyping for Complex Data Mining Tasks,” in Proc. KDD, 2006, the contents of which are incorporated by reference herein. The C-support vector classification (C-SVC) SVM was used with a radial basis function (RBF) kernel, and Logistic Regression with RBF kernel. Logistic Regression in RapidMiner only supports binary classification, and thus it was extended to a multi-class classifier using “one-against-all” strategy for multi-class data sets. See Rifkin et al., “In Defense of One-Vs-All Classification,” J. Machine Learning Research, no. 5, pgs. 101-141 (2004), the contents of which are incorporated by reference herein.

A comparison of class distribution in training samples is now provided. The five sampling methods are first evaluated by comparing the balancedness of the generated training sets. For each run using a given data set, the sampling is continued until the selected training sample contains 50% of the unlabeled sample or 2,000 samples are obtained, whichever is smaller. The metrics computed on completion are the balancedness of the training data and the recall of the minority class, i.e., the number of the minority class selected divided by the total minority samples in an unlabeled data set. As noted above, each run is done with a random 80% of the underlying data sets and results averaged over 10 runs. The balancedness of a data set is measured as a degree of how far the class distribution is from the uniform class distribution.

Definition 2:

Let X be a data set with k different classes. Then the uniform distribution over X is the probability density function (pdf), U(X), where

$${U}_{i} = \frac{1}{k} ,$$

for all iεk. Let P(X) be a pdf over the classes produced by a sampling method. Then the balancedness of the sample is defined as the Euclidean distance between the distributions U(X) and P(X), i.e., d=\sqrt{Σᵢ₌₁^{k}(Uᵢ−Pᵢ)²}.

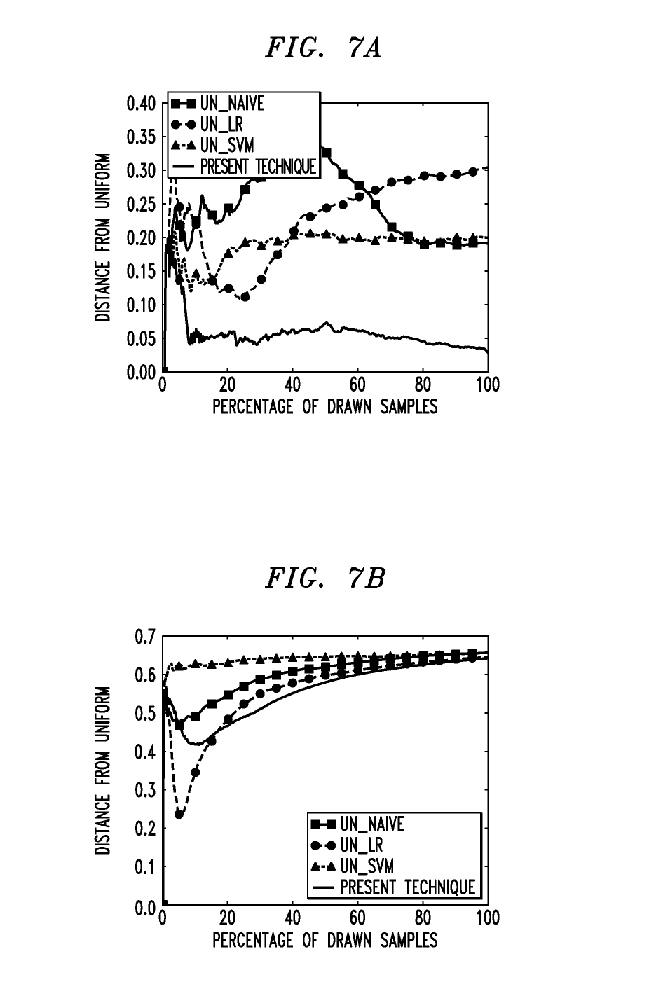

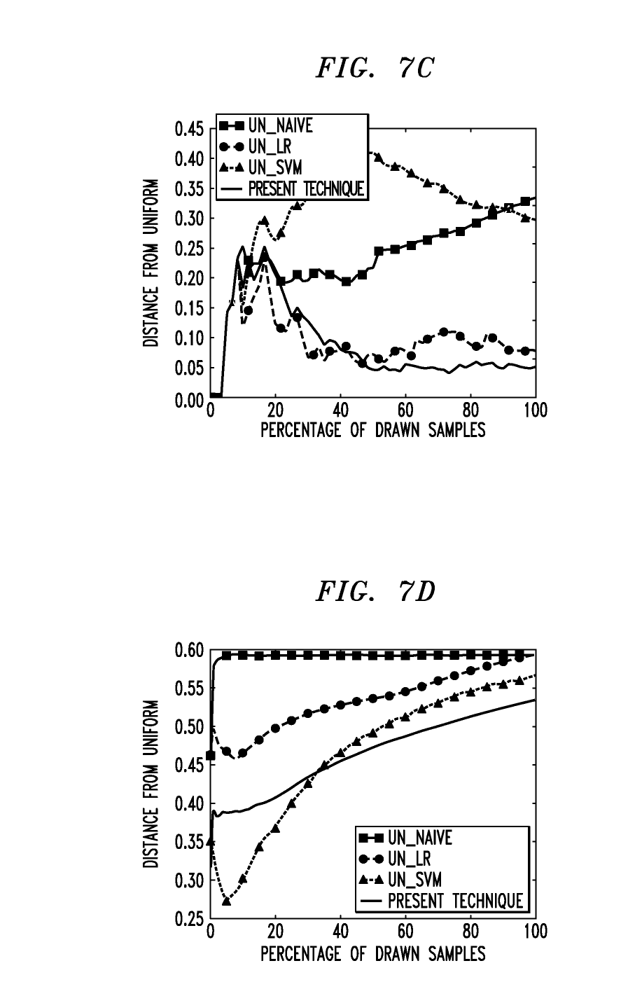

FIGS. 7A-D pictorially depict the performance of the present sampling method as well as the uncertainty based sampling for a few data sets chosen to highlight cases where the present method performs better. In each of FIGS. 7A-D, percentage of drawn samples is plotted on the x-axis and distance from uniform is plotted on the y-axis for Naive Bayes, Logistic Regression, SVM and the present method (labeled “present technique”). FIGS. 7A-D show the progress towards balancedness over iterations measuring distance from uniform against the percentage of data sampled. Compared to the other methods, the present sampling technique consistently converges towards balancedness while there is some variation with the other techniques, which remains true for other data sets as well. While overall trends are clearly noticeable, it matters crucially where in the process the methods are compared. The comparisons being made here are when 50% of the data has been sampled (or when 2,000 samples have been obtained). FIG. 8 is a table 800 that summarizes the results of the evaluation of Random, Our, Un Naive, Un LR and Un SVM on these data sets. Table 800 summarizes distance of the class distributions in the final sample sets to the uniform distance.

It is noted that the present sampling method produces very good results compared to pure random sampling. On KDD Cup 99 the present sampling method yields 10× more minority samples on average than random. Similarly for the access control permission data set on average the present method produces about 2× more balanced samples. For mildly skewed data sets, the present method also produces more balanced samples, producing about 25% more minority samples on the average. For the data sets which are almost balanced, as expected random is the best strategy. Even in this case the present method produces results which are statistically very close to random. Thus the present method is always preferable to random sampling. Since uncertainty based sampling methods are targeted to cases where the classifier to be trained is known, the right comparison with these methods must also include the performance of the resulting classifiers. Further these methods are not very efficient due to re-training at each step. With these caveats, we can still directly show the balancedness of the results. For highly skewed data sets the present method performs better especially when compared to Un SVM and Un Naïve methods. On KDD Cup '99 the present method produced 20× and 2× more minority samples compared to Un Naive and Un SVM respectively while Un LR performs almost as well as the present method. Similarly for PageBlocks the present method perform about 20% better than these methods. For other data sets, the present techniques show no significant statistical difference compared to these methods on almost all cases and sometimes the present method does better. Based on these results, it is also concluded that the present method is preferable to the uncertainty based methods based on broader applicability and efficiency.

FIG. 9 is a table 900 that shows the recall of minority class for all the data sets. The recall is computed by the number of selected minority class samples divided by the number of all minority class samples in the unlabeled data set. Min. Ratio refers to the ratio of the minority class in the unlabeled data set. As can be seen from the results, the present method produces more minority samples. It is noted that, for Page Blocks set, the present method found all minority samples for all 10 split sets.

A comparison of classification performance is now discussed. The best comparison of training samples is the performance of classifiers trained on them. The training samples from the 5 strategies were applied to train the same type of classifiers (Naive, LR, and SVM) to each sampling method, resulting in 15 different “training-evaluation” scenarios. Due to space limitations, the AUC and F1-measure for a few data sets are presented in FIG. 10. FIG. 10 is a table 1000 illustrating classifier performance given sampling technique. It is expected that the performance of the uncertainty sampling methods paired with their respective classifier, e.g., Un-SVM with SVM and Un-LR with Logistic Regression, to perform well. This behavior is not observed on several data sets, including KDD and PIMA. On other data sets, such as breast cancer and a representative access control permission, the present approach performs as well if not better than the competing uncertainty sampling. Thus, the present method performs well without being biased to a single classifier, and at reduced computation cost.

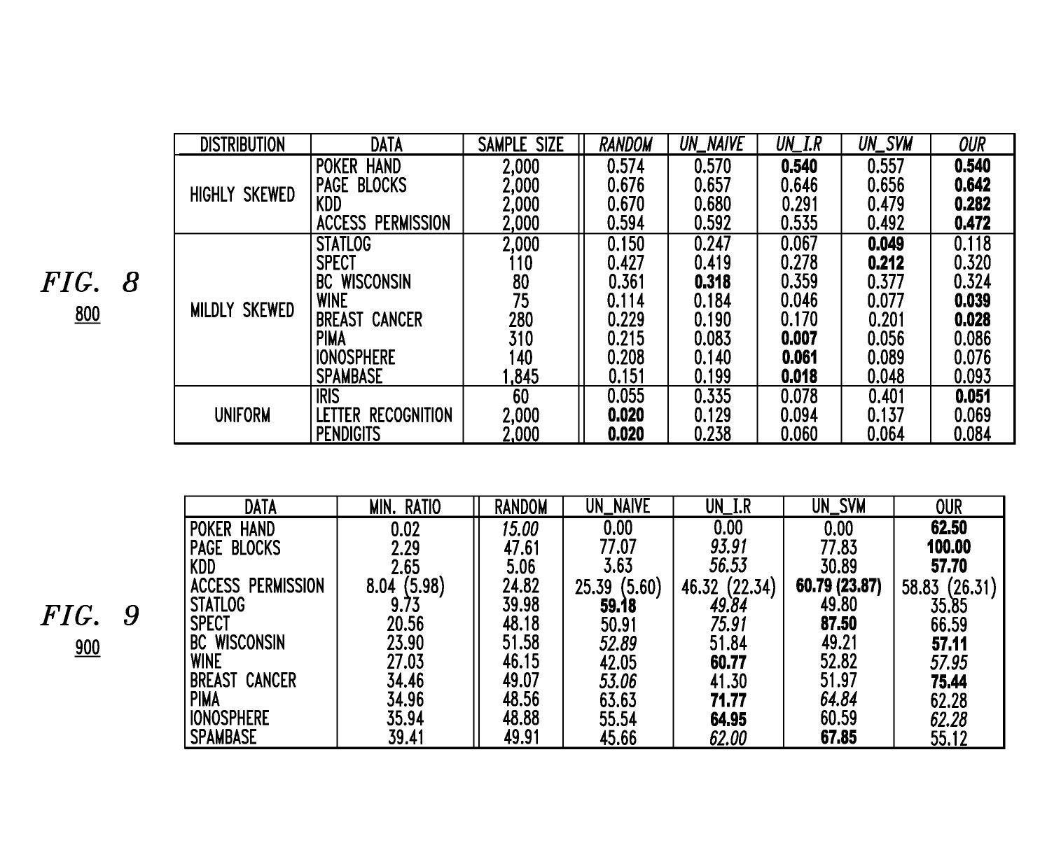

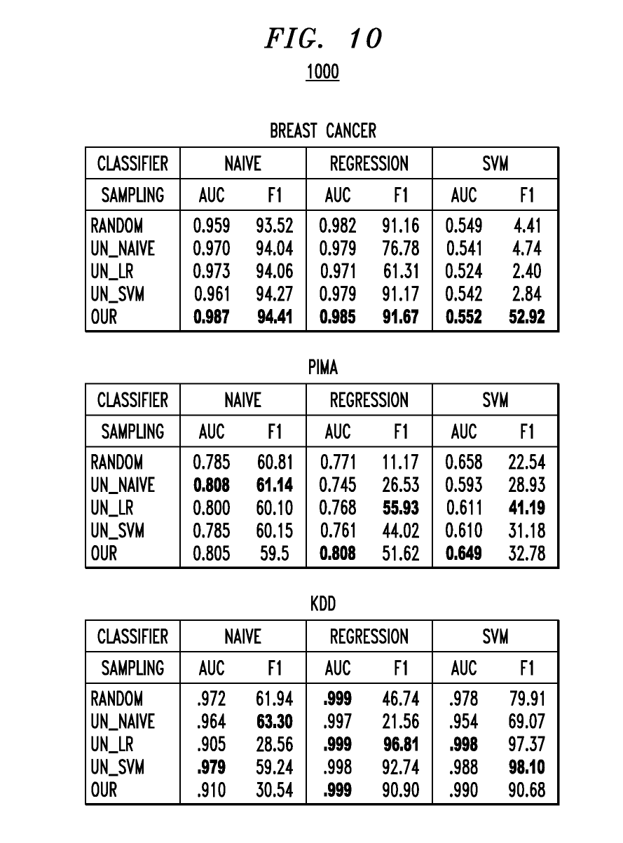

The impact of domain knowledge is now discussed. The access control permission data sets are used to evaluate the benefit of additional domain knowledge given as a correlation of the user's business attributes, e.g., department number, whether he/she is a manager etc. and the permissions granted. The present evaluation of sampling with domain knowledge shows that domain knowledge (almost) always helps. There are a few cases where adding domain knowledge negatively impacts performance. See, for example, FIG. 11A. FIG. 11A is a diagram illustrating the negative impact domain knowledge can have on the performance of the present method. However, in most cases, domain knowledge substantially improves the convergence of the present method. See FIG. 11B. FIG. 11B is a diagram illustrating the positive impact domain knowledge can have on the performance of the present method. In each of FIGS. 11A and 11B, recall of the minority class is plotted on the x-axis and percent minority class is plotted on the y-axis. The example depicted in FIGS. 11A and 11B is typical of the access control data sets. Since such domain knowledge is mostly used in the early iterations it significantly helps speed up the convergence.

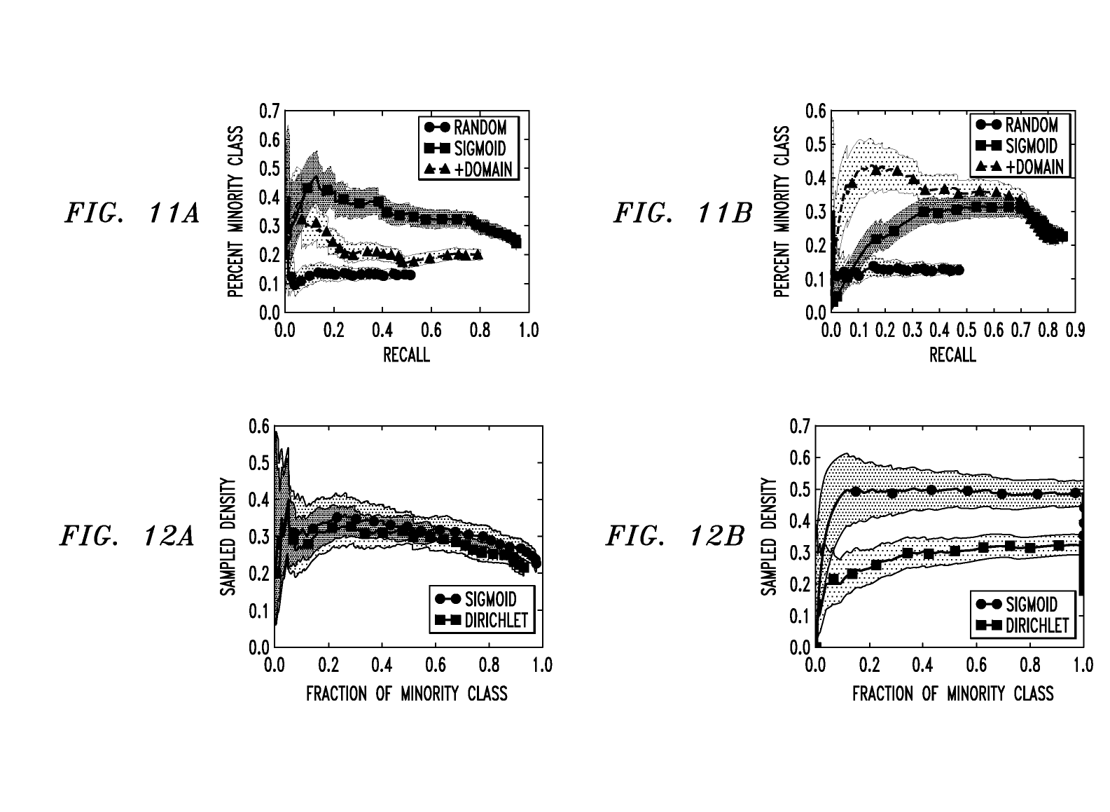

Sampling from clusters with the Dirichlet distribution is now discussed. As mentioned above, the conceptually sound method to sample from each cluster is to sample from a Dirichlet distribution. This approach was evaluated against all of our data sets and mixed results were obtained. See FIGS. 12A and 12B. In each of FIGS. 12A and 12B, fraction of the minority class is plotted on the x-axis and sampled density is plotted on the y-axis. There are a few cases where sampling from clusters using the Dirichlet distribution is better than the hybrid approach. However as noted, in earlier iterations when there are very few labeled samples in each cluster, the Dirichlet distribution defaults to random sampling. It was noticed that in a majority of cases the hybrid approach performs much better than the Dirichlet approach. See FIG. 11B.

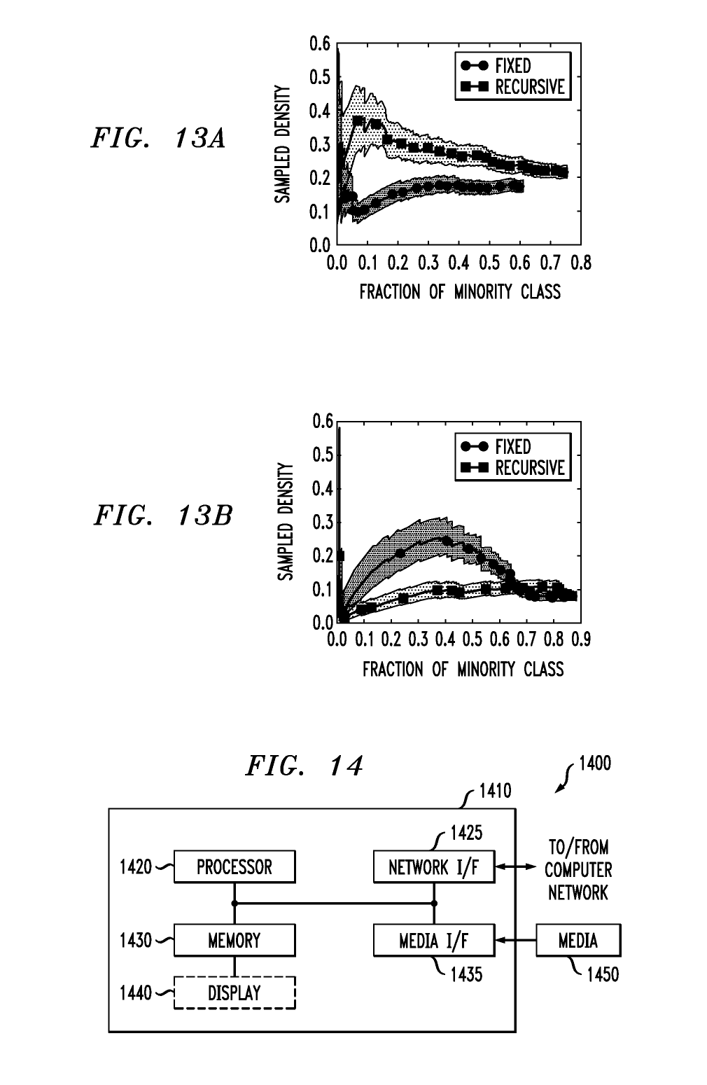

Fixed versus recursive clustering is now discussed. The present method uses a recursive binary clustering technique after a semi-supervised transformation. Clustering is not the final objective, and we are only interested in clusters with low label entropy and it is acceptable to split a single class into multiple clusters. Thus, traditional clustering quality measures, e.g., those described in Lange et al., “Stability-based validation of clustering solutions,” Neural Computation, vol. 16, 1299-1323 (2004), the contents of which are incorporated by reference herein, are not as applicable. Two simple strategies were tested: fixed number of clusters, and recursive binary clustering. The difference between k-means with k=20 and recursive clustering is illustrated on two different access control permissions. See FIGS. 13A and 13B. FIG. 13A is a diagram illustrating an instance where the recursive strategy outperforms that of picking a fixed value of k. FIG. 13B is a diagram illustrating that selecting the optimal value of k can outperform the recursive strategy when k is known a priori. In each of FIGS. 13A and 13B, fraction of the minority class is plotted on the x-axis and sampled density is plotted on the y-axis. In general, a small improvement was noticed when recursive clustering was used, however when k is set non-optimally, e.g., too small, the improvement becomes significant (see FIGS. 12A and 12B with a comparison with random sampling).

There is an extensive body of related work on generating “good” training data sets. A common approach is active learning, which iteratively selects informative samples, e.g., near the classification border, for human labeling. See, for example, Settles; Campbell et al., “Query Learning with Large Margin Classifiers,” in ICML, 2000; Freund et al., “Selective Sampling Using the Query by Committee Algorithm,” Machine Learning, vol. 28, no. 2-3, pgs. 133-168 (1997) (hereinafter “Freund”); and Tong et al., “Support Vector Machine Active Learning with Applications to Text Classification,” in ICML, 2000, the contents of each of which are incorporated by reference herein. The sampling schemes most widely used in active learning are uncertainty sampling and Query-By-Committee (QBC) sampling. See, for example, Freund; Lewis et al., “A Sequential Algorithm for Training Text Classifiers,” in SIGIR, 1994; Seung et al., “Query by Committee,” in Computational Learning Theory,” 1992, the contents of each of which are incorporated by reference herein. Uncertainty sampling selects the most informative sample determined by one classification model, while QBC sampling determines informative samples by a majority vote.

Another approach is re-sampling, i.e., over- and under-sampling classes (see Liu and Chawla), however this requires labeled data. Recent work combines active learning and re-sampling to address class imbalance in unlabeled data. Tomanek et al., “Reducing Class Imbalance during Active Learning for Named Entity Annotation,” in K-CAP, 2009 (hereinafter “Tomanek”), the contents of which are incorporated by reference herein, propose incorporating a class-specific cost in the framework of QBC-based active learning for named entity recognition. By setting a higher cost for the minority class, this method boosts the committee's disagreement value on the minority class resulting in more minority samples in the training set. Zhu et al., “Active Learning for Word Sense Disambiguation with Methods for Addressing the Class Imbalance Problem,” in EMNLP-CoNLL, pgs. 783-790 (2007) (hereinafter “Zhu”), the contents of which are incorporated by reference herein, incorporate over- and under-sampling in active learning for word sense disambiguation. Zhu uses active learning to select samples for human experts to label, and then re-samples this subset. In their experiments under-sampling caused negative effects but over-sampling helps increase balancedness.

The present approach is iterative like active learning but it differs crucially in that it relies on semi-supervised clustering instead of classification. This makes it more general where the best classifier is not known in advance or ensemble techniques are used. As shown in FIG. 10, the present method performs consistently across all classifiers whereas the off-diagonal entries for uncertainty based sampling show poor results, i.e., when there is a mismatch between sampling and classifier techniques. The present method is the first attempt at using active learning with semi-supervised clustering instead of classification and thus does not suffer from over-fitting.

Another problem with active learning is that the update process is very expensive as it requires classification of all data samples and retraining of the model at each iteration. This cost is prohibitive for large scale problems. Techniques such as batch mode active learning have been proposed to improve the efficiency of uncertainty learning. See, for example, Hoi et al., “Batch Mode Active Learning and Its Application to Medical Image Classification,” in ICML, 2006 and Guo et al., “Discriminative Batch Mode Active Learning,” the Twenty-First Annual Conference on Neural Information Processing Systems (NIPS) (2007) (hereinafter “Guo”), the contents of each of which are incorporated by reference herein. However, as the batch size grows, the effectiveness of active learning decreases. See, for example, Guo; Schohn et al., “Less is More: Active Learning with Support Vector Machines,” in ICML, 2000; Xu et al., “Greedy is not Enough: An Efficient Batch Mode Active Learning Algorithm,” In ICDM Workshops, 2009, the contents of each of which are incorporated by reference herein. The present approach selects target samples based on estimated class distribution in each cluster.

Since, most classification methods require the presence of at least two different classes in the training set, there is a challenge in providing the initial labeling sample for active learning. Simply using a random sample will not work. The present method does not have this limitation and although not shown in the experiments, performs as well with a random initial sample. Lastly, current methods (Zhu) and (Tomanek) are primarily designed and applied to binary classification problems for text and are hard to generalize to multi-class problems and non-text domains. In contrast, the present techniques provide a general framework which is domain independent and can be easily customized to specific domains.

Turning now to FIG. 14, a block diagram is shown of an apparatus 1400 for implementing one or more of the methodologies presented herein. By way of example only, apparatus 1400 can be configured to implement one or more of the steps of methodology 100 of FIG. 1 for obtaining balanced training sets.

Apparatus 1400 comprises a computer system 1410 and removable media 1450. Computer system 1410 comprises a processor device 1420, a network interface 1425, a memory 1430, a media interface 1435 and an optional display 1440. Network interface 1425 allows computer system 1410 to connect to a network, while media interface 1435 allows computer system 1410 to interact with media, such as a hard drive or removable media 1450.

As is known in the art, the methods and apparatus discussed herein may be distributed as an article of manufacture that itself comprises a machine-readable medium containing one or more programs which when executed implement embodiments of the present invention. For instance, when apparatus 1400 is configured to implement one or more of the steps of process 100 the machine-readable medium may contain a program configured to select a small initial set of data from the unlabeled data set; acquire labels for the initial set of data selected from the unlabeled data set resulting in labeled data; cluster the data in the unlabeled data set using a semi-supervised clustering process along with the labeled data to produce a plurality of data clusters; choose data samples from each of the clusters to use as the training data; and repeat the selecting, presenting, clustering and choosing steps with one or more additional sets of data selected from the unlabeled data set until a desired amount of training data has been obtained, wherein at each iteration an amount of the labeled data is increased.

The machine-readable medium may be a recordable medium (e.g., floppy disks, hard drive, optical disks such as removable media 1450, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Processor device 1420 can be configured to implement the methods, steps, and functions disclosed herein. The memory 1430 could be distributed or local and the processor device 1420 could be distributed or singular. The memory 1430 could be implemented as an electrical, magnetic or optical memory, or any combination of these or other types of storage devices. Moreover, the term “memory” should be construed broadly enough to encompass any information able to be read from, or written to, an address in the addressable space accessed by processor device 1420. With this definition, information on a network, accessible through network interface 1425, is still within memory 1430 because the processor device 1420 can retrieve the information from the network. It should be noted that each distributed processor that makes up processor device 1420 generally contains its own addressable memory space. It should also be noted that some or all of computer system 1410 can be incorporated into an application-specific or general-use integrated circuit.

Optional video display 1440 is any type of video display suitable for interacting with a human user of apparatus 1400. Generally, video display 1440 is a computer monitor or other similar video display.

In conclusion, considered herein is the problem of generating a training set that can optimize the classification accuracy and also is robust to classifier change. A general strategy is proposed that applies a semi-supervised clustering method and a maximum entropy-based sampling method. It was confirmed through experiments that the present method produces very balanced training data for highly skewed data sets and outperforms other methods in correctly classifying the minority class. For a balanced multi-class problem, the present techniques outperform active learning by a large margin and work slightly better than random sampling. Furthermore, the present method is much faster compared to active sampling. Therefore, the proposed method can be successfully applied to many real-world applications with highly imbalanced class distribution such as malware detection or fraud detection.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for generating training data from an unlabeled data set, comprising the steps of:
selecting a small initial set of data from the unlabeled data set;
acquiring labels for the initial set of data selected from the unlabeled data set resulting in labeled data;
clustering the data in the unlabeled data set using a semi-supervised clustering process along with the labeled data to produce a plurality of data clusters;
choosing data samples from each of the clusters to use as the training data; and
repeating the selecting, presenting, clustering and choosing steps with one or more additional sets of data selected from the unlabeled data set until a desired amount of training data has been obtained, wherein at each iteration an amount of the labeled data is increased.

2. The method of claim 1, wherein the initial set of data is generated by random sampling from the unlabeled data set.

3. The method of claim 1, wherein a size of the initial set of data is based on a predetermined percentage of the desired amount of training data, and wherein at each iteration a size of each of the additional sets of data is based on the predetermined percentage of the desired amount of training data.

4. The method of claim 1, further comprising the steps of:
estimating a class distribution of each of the clusters to obtain an estimated class distribution for each of the clusters; and
performing a biased sampling to choose the data samples from the clusters based on the estimated class distribution for each of the clusters.

5. The method of claim 4, wherein the class distribution of each of the clusters is estimated based on one or more of: a class distribution of previously labeled samples in each of the clusters, additional domain knowledge on correlations between features and class labels, and uniform distribution.

6. The method of claim 1, further comprising the step of:
determining a number of data samples to choose from each of the clusters.

7. The method of claim 6, wherein the number of data samples chosen from each of the clusters is determined based on one or more estimates of class distribution.

8. The method of claim 7, wherein a final estimate is determined using a weight function when two different estimates of class distribution are used.

9. The method of claim 8, wherein the weight function is a sigmoid function ω,
$$ω = \frac{1}{1 + {e}^{- λ t}}$$
wherein, t denotes t-th iteration of the method and λ is a parameter that controls a rate of mixing of the two different estimates.

10. The method of claim 4, wherein the biased sampling is performed to choose the data samples based on the estimated class distribution for each of the clusters, the method further comprising the steps of:
computing a class distribution of previously labeled samples;
computing a number of samples to draw for each class which is inversely proportional to the class distribution of previously labeled samples;
computing a class distribution of previously labeled samples in each of the clusters;
computing the number of samples to draw from each of the clusters based on the class distribution of previously labeled samples in each of the clusters.

11. The method of claim 1, further comprising the step of:
applying maximum entropy sampling to select the data samples from each of the clusters to minimize any sample bias introduced by the semi-supervised clustering process.

12. The method of claim 1, wherein input parameters to the method comprise i) the unlabeled data set, ii) a number of target classes in the unlabeled data set and iii) the desired amount of training data.

13. The method of claim 1, wherein the semi-supervised clustering process comprises Relevant Component Analysis (RCA).

14. The method of claim 1, wherein the semi-supervised clustering process comprises augmenting the feature set with labels.

15. The method of claim 13, wherein the clustering step comprises the steps of:
translating the labeled data into connected components;
learning a global distance metric parameterized by a transformation matrix to capture one or more relevant features in the labeled data;
projecting the data from the data set into a new space using the global distance metric; and
recursively partitioning the data into clusters until all of the clusters are smaller than a predetermined threshold.

16. An apparatus for generating training data from an unlabeled data set, the apparatus comprising:
a memory; and
at least one processor device, coupled to the memory, operative to:
select a small initial set of data from the unlabeled data set;
acquire labels for the initial set of data selected from the unlabeled data set resulting in labeled data;
cluster the data in the unlabeled data set using a semi-supervised clustering process along with the labeled data to produce a plurality of data clusters;
choose data samples from each of the clusters to use as the training data; and
repeat the selecting, presenting, clustering and choosing steps with one or more additional sets of data selected from the unlabeled data set until a desired amount of training data has been obtained, wherein at each iteration an amount of the labeled data is increased.

17. The apparatus of claim 16, wherein the at least one processor device is further operative to:
determine a number of data samples to choose from each of the clusters.

18. The apparatus of claim 16, wherein the at least one processor device is further operative to:
apply maximum entropy sampling to select the data samples from each of the clusters to minimize any sample bias introduced by the semi-supervised clustering process.

19. The apparatus of claim 16, wherein the semi-supervised clustering process comprises Relevant Component Analysis (RCA).

20. An article of manufacture for generating training data from an unlabeled data set, comprising a machine-readable recordable medium containing one or more programs which when executed implement the steps of:
selecting a small initial set of data from the unlabeled data set;
acquiring labels for the initial set of data selected from the unlabeled data set resulting in labeled data;
clustering the data in the unlabeled data set using a semi-supervised clustering process along with the labeled data to produce a plurality of data clusters;
choosing data samples from each of the clusters to use as the training data; and
repeating the selecting, presenting, clustering and choosing steps with one or more additional sets of data selected from the unlabeled data set until a desired amount of training data has been obtained, wherein at each iteration an amount of the labeled data is increased.

21. The article of manufacture of claim 20, wherein the one or more programs which when executed further implement the step of:
determining a number of data samples to choose from each of the clusters.

22. The article of manufacture of claim 20, wherein the one or more programs which when executed further implement the step of:
applying maximum entropy sampling to select the data samples from each of the clusters to minimize any sample bias introduced by the semi-supervised clustering process.

23. The article of manufacture of claim 20, wherein the semi-supervised clustering process comprises Relevant Component Analysis (RCA).
